(19) United States
(12) Patent Application Publication
(10) Pub. No.: US 2024/0162600 A1
(43) Pub. Date: May 16, 2024

(54) ANTENNA DEVICE

(71) Applicant: YOKOWO CO., LTD., Chiyoda-ku, Tokyo (JP)

(72) Inventors: Takashi NOZAKI, Tomioka-Shi, Gunma (JP); Noritaka TERASHITA, Tomioka-Shi, Gunma (JP)

(73) Assignee: YOKOWO CO., LTD., Chiyoda-ku, Tokyo (JP)

(21) Appl. No.: 18/283,816

(22) PCT Filed: Feb. 24, 2022
(86) PCT No.: PCT/JP2022/007512

§ 371 Date: Sep. 25, 2023

Related U.S. Application Data
(60) Provisional application No. 63/165,795, filed on Mar. 25, 2021.

(51) Int. Cl. H01Q 1/32; H01Q 9/04; H01Q 21/28

(52) U.S. Cl. CPC H01Q 1/3275; H01Q 9/0414; H01Q 9/0421; H01Q 21/28

(57) ABSTRACT

An antenna device includes: a first substrate disposed at an end portion of a ground member in one direction of a front direction and a rear direction of a vehicle, the ground member being configured to be attached to a reinforcement member of the vehicle; and a first antenna element provided at the first substrate, the first antenna element including a first upright portion formed to extend upright relative to the first substrate, and a first arm portion extending from the first upright portion, and overlapping with the end portion of the ground member in a plan view.

### TECHNICAL FIELD

The present disclosure relates to an antenna device.

### BACKGROUND ART

PTL 1 discloses an antenna device accommodating a plurality of antennas.

### CITATION LIST

### Patent Literature

[PTL 1] Japanese Patent Application Publication No. 2016-208291

### SUMMARY OF INVENTION

### Technical Problem

When the distance between antennas accommodated in an antenna device and a ground member decreases in association with a reduction in the height of the antenna device, the parasitic capacitance between the antennas and the ground member may affect the characteristics of the antennas.

In view of such an issue as above, the present disclosure is directed to reduction in influence on characteristics of antennas, for example.

### Solution to Problem

An aspect of the present disclosure is an antenna device comprising: a first substrate disposed at an end portion of a ground member in one direction of a front direction and a rear direction of a vehicle, the ground member being configured to be attached to a reinforcement member of the vehicle; and a first antenna element provided at the first substrate, the first antenna element including a first upright portion formed to extend upright relative to the first substrate, and a first arm portion extending from the first upright portion, and overlapping with the end portion of the ground member in a plan view.

Another aspect of the present disclosure is an antenna device comprising: a ground member configured to be attached to a reinforcement member of a vehicle, the ground member extending, from the reinforcement member, in one direction of a front direction and a rear direction of the vehicle;
a first substrate disposed at an end portion of the ground member in the one direction; and a first antenna element provided at the first substrate, the first antenna element including a first upright portion formed to extend upright relative to the first substrate, and a first arm portion extending from the first upright portion, and overlapping with the end portion of the first substrate in the first direction, in a plan view of the first substrate.

According to an aspect of the present disclosure, it is possible to provide an antenna device capable of reducing influence on the characteristics of antennas accommodated therein.

### BRIEF DESCRIPTION OF DRAWINGS

FIG. 1 is a side view of a vehicle C at which an antenna device 10 is installed and illustrates a partial cross-section.

FIG. 2 is a diagram illustrating the relationship between a frame F of the vehicle C and the antenna device 10.

FIG. 3 is an exploded perspective view of the antenna device 10.

FIG. 4A is a perspective view of an antenna device 30A with a cover 61A omitted, and FIG. 4B is a perspective view of an antenna device 30B with a cover 61B omitted.

FIG. 5 is a diagram illustrating an antenna 50A.

FIG. 6A is a diagram illustrating an example of the position of an arm portion 110A, FIG. 6B is a diagram illustrating another example of the position of the arm portion 110A, and FIG. 6C is a plan view of the arm portion 110A and a ground member 200.

FIG. 7A is a diagram illustrating an example of parasitic capacitance of the arm portion 110A, and FIG. 7B is a diagram illustrating another example of parasitic capacitance of the arm portion 110A.

FIG. 8 is a diagram illustrating the positions of the arm portions 110A, 110B of the antenna device 10.

FIG. 9A is a diagram illustrating isolation between the antennas 50A and 50B, FIG. 9B is a diagram illustrating isolation between antennas 51A and 51B, and FIG. 9C is a diagram illustrating isolation between antennas 52A and 52B.

FIG. 10 is a diagram illustrating the horizontal directivity of the antenna 52A.

FIG. 11 is a diagram illustrating the horizontal directivity of the antenna 52B.

FIG. 12 is a diagram illustrating the disposition of the antenna device 300 with respect to the vehicle C.

FIG. 13 is a partially-exploded perspective view of an antenna device 300.

### DESCRIPTION OF EMBODIMENTS

At least the following matters become apparent from the descriptions of the specification and the drawings attached thereto.

Preferred embodiments of the present disclosure will be described below with reference to the drawings. The same or equivalent components, members, and the like illustrated in the drawings are given the same reference signs, and a repetitive description thereof is omitted as appropriate.

### Installation Location of Antenna Device 10 With Respect to Vehicle C

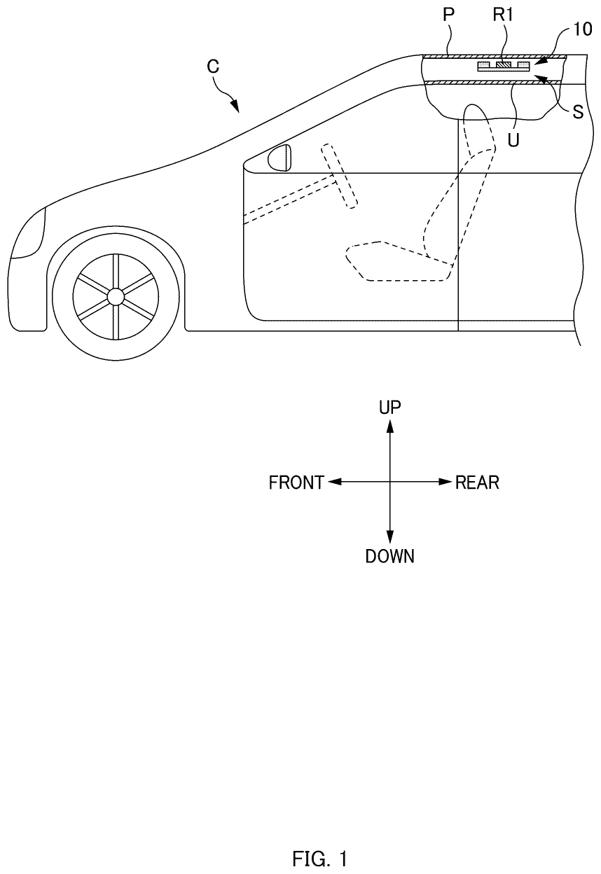

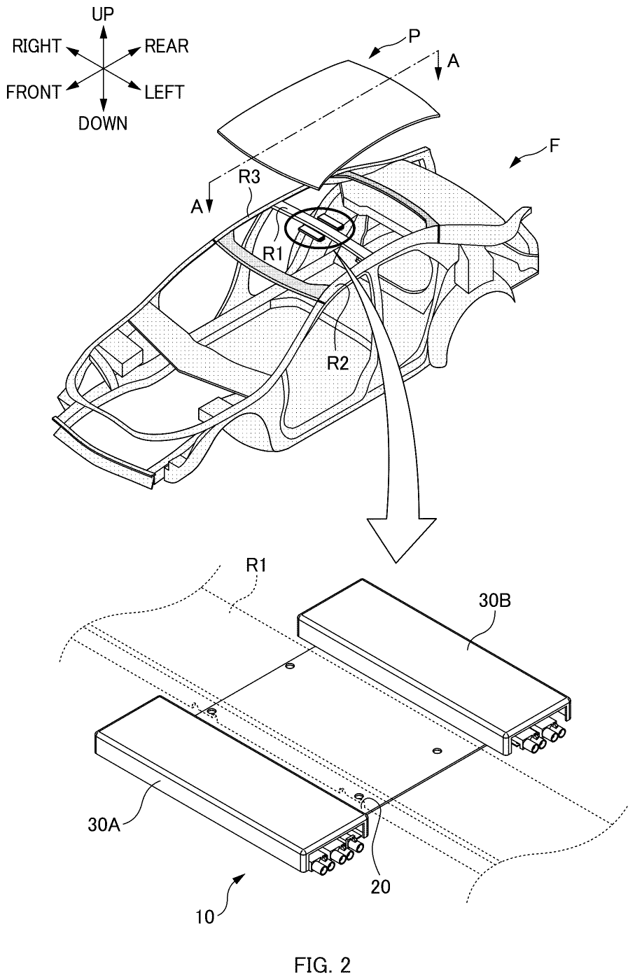

First, with reference to FIGS. 1 and 2, a description is given of the installation location of an antenna device 10 with respect to a vehicle C in an embodiment of the present disclosure. FIG. 1 is a diagram illustrating a side face of the vehicle C and a partial cross-section of the vehicle C. FIG. 2 is a diagram illustrating the positional relationship between a frame F of the vehicle C and the antenna device 10. The partial cross-sectional view in FIG. 1 is an enlarged view of a vehicle interior ceiling portion in the cross-section of the vehicle C taken along the line A-A of FIG. 2.

In the following description, directions are defined with reference to the vehicle C as illustrated in FIG. 1. Specifically, a direction in which the vehicle C travels forward as seen from the driver's seat is the front, and the direction opposite thereto is the rear. The width direction of the vehicle C orthogonal to the travelling direction is a left-right direction. Regarding the directions penetrating the paper plane of FIG. 1, the direction to the nearer side is the left direction, and the direction to the farther side is the right direction. Further, an up-down direction is defined in accordance with the top and bottom of the vehicle C. The definitions of the directions and the like described above are common herein unless otherwise noted.

The antenna device 10 is a vehicular antenna device for vehicles, and includes antenna devices 30A, 30B (described later) each including a plurality of antennas, and is used at the vehicle C, which is a wheeled means of transportation. A space S is formed in the vehicle C at a location below a roof panel P which is at the upper surface thereof and above a vehicle interior ceiling surface U. The antenna device 10 is attached to a reinforcement member R1 located in the space S.

The roof panel P is a dielectric panel that allows electromagnetic waves (hereinafter referred to as “radio waves”) to pass therethrough, and is provided at the vehicle C in such a manner as to cover the vehicle interior ceiling surface U from above.

As illustrated in FIG. 2, the frame F of the vehicle C is metallic. The reinforcement member R1 and roof side rails R2, R3 are provided at the ceiling part of the vehicle C as part of the frame F. The reinforcement member R1 is a member provided between the roof side rails R2 and R3 to reinforce the vehicle C. Alternatively, the antenna device 10 may be attached to the frame F, which constitutes the vehicle C, instead of the reinforcement member R1. Further, the antenna device 10 may be an antenna device not for vehicles.

The space S in which the antenna device 10 is to be accommodated is limited in size. Thus, the antenna devices 30A, 30B constituting the antenna device 10 needs miniaturization (particularly, reduction in the heights thereof in the up-down direction).

### Configuration of Antenna Device 10

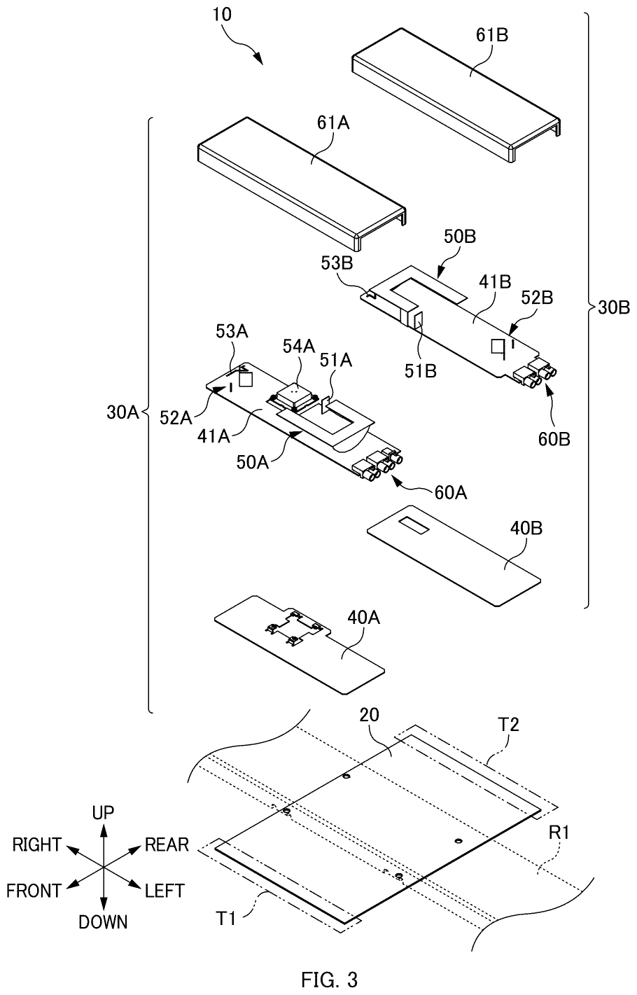

As illustrated in, for example, FIGS. 2 and 3, the antenna device 10 includes a ground member 20, the antenna device 30A, and the antenna device 30B. FIG. 3 is an exploded perspective view of the antenna device 10.

In an embodiment of the present disclosure, a description is given of the antenna device 10 as including the ground member 20, however, it may be assumed that the antenna device 10 does not include the ground member 20. For example, the ground member 20, the antenna device 30A, and the antenna device 30B may constitute the antenna device 10 as one set, in some cases, or the ground member 20 may be handled separately from the antenna device 30A and the antenna device 30B in other cases. In the case where the ground member 20 is handled separately, the antenna device 30A and/or the antenna device 30B corresponds to the antenna device 10.

### Ground Member 20

The ground member 20 is a substantially quadrilateral plate-shaped metal member functioning as a ground of the antenna device 10 and is secured to a lower side of the metallic reinforcement member R1 with a conductive screw (not illustrated) and/or the like. Thus, the ground member 20 is connected to the reinforcement member R1 physically and electrically.

Further, in an embodiment of the present disclosure, the ground member 20 is secured, at the substantially central portion thereof in the front-rear direction, to the reinforcement member R1 so as to extend both frontward and rearward of the reinforcement member R1. Although the ground member 20 extends both frontward and rearward relative to the reinforcement member R1 in an embodiment of the present disclosure, the ground member 20 may extend only either frontward or rearward.

The term “substantially quadrilateral” used herein refers to a shape formed by four sides including a square and a rectangle, for example. Further, for example, at least part of corners thereof may be cut away obliquely relative to a side of the shape, or at least part of corners thereof may include curvature. Further, a “substantially quadrilateral” shape may include a notch (recessed portion) or a protrusion (protruding portion) at part of sides thereof. Although it is assumed here that the ground member 20 is substantially quadrilateral, the ground member 20 may have a shape other than the above (e.g., a circle or a polygon other than a quadrilateral) as long as the antenna device 10 can be attached thereto.

Further, hereinafter, to “connect” includes not only to physically connect but also to “electrically connect,” unless otherwise noted. To electrically connect is not limited to connection through a conductor, but includes connection through an electric circuit, an electric component, and/or the like. The same applies to the following descriptions as well.

### Configuration of Antenna Device 30A

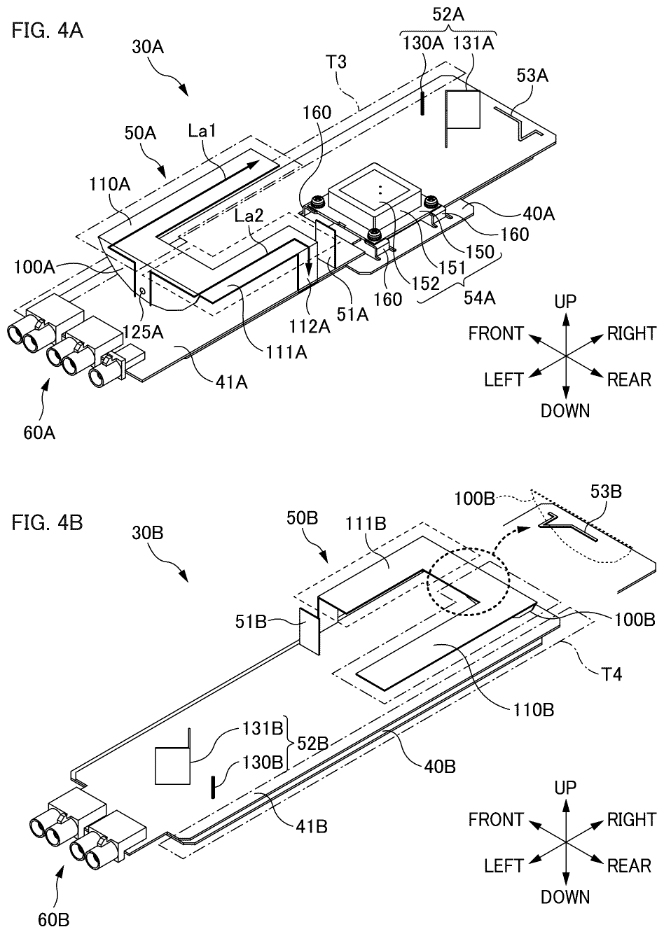

The antenna device 30A is, as illustrated in FIGS. 3 and 4A, a complex antenna accommodating a plurality of antennas, and includes a ground member 40A, a substrate 41A, antennas 50A to 54A, a connector 60A, and a cover 61A.

The ground member 40A is a metallic, substantially quadrilateral plate-shaped member functioning as a ground of the antenna device 30A, and is secured to a front end portion T1 of the ground member 20 with a conductive screw (not illustrated). As a result, the ground member 20 and the ground member 40A are electrically connected to each other.

Although the antenna device 30A includes the ground member 40A in an embodiment of the present disclosure, the present disclosure is not limited to this. Specifically, the antenna device 30A may exclude the ground member 40A, and the substrate 41A (described later) may be directly provided at the ground member 20.

Further, the “front end portion T1 of the ground member 20” indicates a certain region including the end, as depicted by the dot-dot-dash line region at the front in FIG. 3, without indicating the exact front end of the ground member 20. Although the front end portion T1 has been described here, the same applies to the end portion of the ground member 20 in another direction (e.g., a rear end portion T2).

The substrate 41A at which the antennas 50A to 54A are to be provided on the upper side of the ground member 40A. The substrate 41A is a substantially rectangular member whose edges extending in the left-right direction are longer than the edges extending in the front-rear direction. The substrate 41A is electrically connected to the antenna 50A via a feed point 125.

The connector 60A connected to signal lines from the respective antennas 50A to 54A is provided at a left end portion of the substrate 41A. Further, in an embodiment of the present disclosure, when the cover 61A is attached to cover the substrate 41A, the substrate 41A and the cover 61A form an accommodation space to accommodate the antennas 50A to 54A.

### Antenna 50A

The antenna 50A is a wideband antenna (telematics antenna) for mobile communications and supports radio waves in the Sub-6 band of 699 MHz to 5000 MHz (5 GHz) in GSM, UMTS, LTE, and fifth-generation mobile communication system (5G), for example.

The GSM stands for “Global System for Mobile communications,” and UMTS stands for “Universal Mobile Telecommunications System.” LTE stands for “Long Term Evolution.” Further, the antenna 50A is not limited to the communication standards described above, but may support radio waves in other frequency bands for telematics.

In the following description, in the frequency band of radio waves supported by the antenna 50A, a predetermined frequency band on the lower-side may be referred to as “low frequency band.” In an embodiment of the present disclosure, the low frequency band is, for example, a band from 699 MHz to 960 MHz. Further, a predetermined frequency band on the higher side relative to the low frequency band may be referred to as “intermediate and high frequency bands” (or “intermediate frequency band” and “high frequency band”).

In an embodiment of the present disclosure, the intermediate and high frequency bands refer to, for example, both of the 1710 MHz to 2690 MHz band (intermediate frequency band) and the 3300 MHz to 5000 MHz band (high frequency band). However, the present disclosure is not limited to these examples of the “low frequency band,” the “intermediate frequency band,” and the “high frequency band,” but they may be different depending on the frequency band of radio waves supported by the antenna 50A.

The antenna 50A includes an upright portion 100A, arm portions 110A, 111A extending from the upright portion 100A, and a short-circuit portion 112A.

The upright portion 100A is a portion (part of an element) provided to achieve matching at least in the high frequency band in the frequency band of radio waves supported by the antenna 50A, and is formed to extend upright from the substrate 41A. Although the upright portion 100A is formed to extend upright from the substrate 41A substantially perpendicularly (substantially 90°) here, the upright portion 100A may be formed to extend upright obliquely at an angle different from substantially 90°.

The feed point 125A of the antenna 50A is provided at a lower end portion of the upright portion 100A. Further, the upright portion 100A forms a substantially semicircular shape having a downward arc when seen in the left-right direction. Thus, a length in the front-rear direction (hereinafter also referred to as width) of an upper end portion of the upright portion 100A is larger than that of the lower end portion thereof. The shape of the upright portion 100A is not limited to the semicircular shape. But the upright portion 100A may have a different shape such as a polygon, and the length of the upper end portion in the front-rear direction may be longer than that of the lower end portion.

The arm portion 110A is a portion (part of the element) provided so as to resonate in the low frequency band in the frequency band of radio waves supported by the antenna 50A. As indicated by the region surrounded by the dot-dash line in FIG. 4A, the arm portion 110A extends from the upright portion 100A in such a manner as to extend along the front edge (the edge extending in the left-right direction) of the substrate 41A so as to overlap with a front end portion T3 of the substrate 41A in a plan view of the substrate 41A.

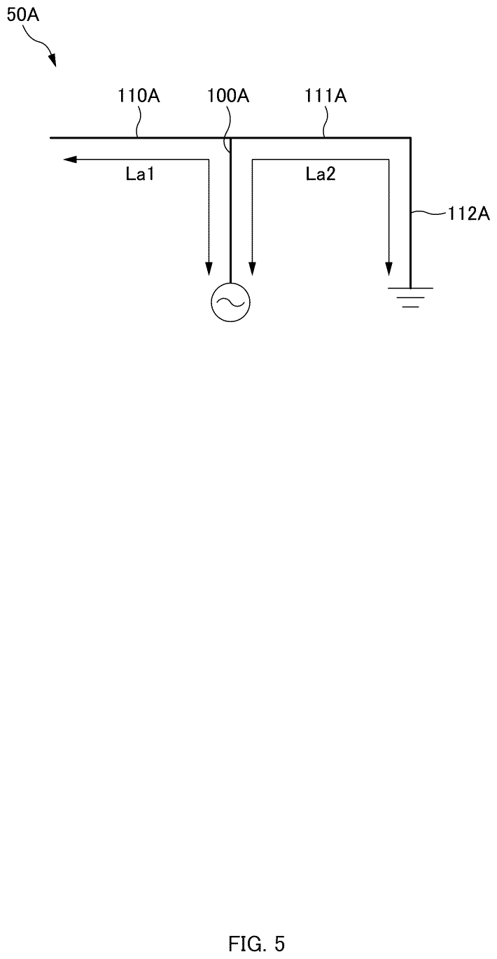

The arm portion 110A in an embodiment of the present disclosure is formed to correspond to a length La1 and width in accordance with the wavelength used in the low frequency band (e.g., the wavelength at 699 MHz) from the feed point 125A to an open end thereof via the upright portion 100A. Thus, as illustrated in FIG. 5, in the antenna 50A, the arm portion 110A and the upright portion 100A function as an antenna supporting the low frequency band and based on an inverted-L antenna.

The “front end portion T3 of the substrate 41A” indicates a certain region including the end, as depicted by the dot-dash line in FIG. 4A, without indicating the exact front end of the substrate 41A. Although the front end portion T3 has been described here, the same applies to the end portion in another direction as well.

The arm portion 111A is a portion (part of the element) provided so as to resonate in the intermediate frequency band in the frequency band of radio waves supported by the antenna 50A. As indicated by the region surrounded by the dotted line in FIG. 4A, the arm portion 111A extends from the upright portion 100A in such a manner as to extend along the rear edge of the substrate 41A so as to overlap with a rear end portion of the substrate 41A in a plan view of the substrate 41A. The region of the rear end portion of the substrate 41A is not depicted for convenience.

The arm portion 111A in an embodiment of the present disclosure is formed to correspond to a length La2 and width in accordance with the wavelength used in the intermediate frequency band (e.g., the wavelength at 1710 MHz) from the feed point 125A to the ground member 40A via the upright portion 100A, the arm portion 111A, and then the short-circuit portion 112A. Further, the short-circuit portion 112A extends downward from the right side of the tip end portion of the arm portion 111A to electrically short-circuit the arm portion 111A to the ground member 40A.

Thus, as illustrated in FIG. 5, in the antenna 50A, the arm portion 111A and the short-circuit portion 112A, together with upright portion 100A, function as an antenna supporting the intermediate frequency band and based on a bent monopole antenna.

In an embodiment of the present disclosure, the front direction corresponds to a “first direction,” and the substrate 41A corresponds to a “first substrate.” Further, the upright portion 100A corresponds to a “first upright portion,” the arm portion 110A corresponds to a “first arm portion,” and the antenna 50A corresponds to a “first antenna element.”

### Antenna 51A

The antenna 51A is a wide-band antenna (telematics antenna) for mobile communications and supports radio waves for the Sub-6 frequency band from 3.3 GHz to less than 5 GHz in LTE or fifth-generation mobile communication system (5G), for example. The antenna 51A is not limited to the communication standards described above, but may support radio waves in other frequency bands for telematics.

### Antenna 52A

The antenna 52A is an antenna supporting radio waves in a frequency band used for vehicle-to-everything (V2X: vehicle-to-vehicle communications, road-to-vehicle communications), for example. The antenna 52A includes elements 130A, 131A. The antenna 52A corresponds to a “first antenna for vehicle communications.” The antenna 52A is disposed on the substrate 41A at a position away from the position of the antenna 51A.

The element 130A is a bar-shaped conductor that is used for V2X communications and operates as a monopole antenna for vertical polarization. The element 130A is electrically connected, at the lower end thereof, to the substrate 41A, to be supplied with power.

The element 131A is a parasitic element placed near the element 130A. The element 131A is a conductive, plate-shaped member provided to stand upward from the substrate 41A and has a self-similar shape bent to spread rearward. Then, the bent portion and the element 130A are arranged to be aligned in the front-rear direction.

The element 131A operates as a so-called reflector and has a function to improve the gain of the antenna 52A in the front of the vehicle C by reflecting radio waves emitted from the element 130A to the front of the vehicle C. Although it is assumed here that the antenna 52A includes the elements 130A, 131A, the antenna 52A may include only the element 130A, for example.

### Antenna 53A

The antenna 53A is an antenna supporting radio waves in a frequency band used for Wi-Fi and Bluetooth, for example. Wi-Fi and Bluetooth are registered trademarks.

### Antenna 54A

The antenna 54A is a patch antenna that is used for Global Navigation Satellite System (GNSS) and supports the frequency band for GLASS. The frequency band for GLASS is, for example, the L1 band (center frequency: 1575.42 MHz), the L2 band (center frequency: 1227.60 MHz), or the L5 band (center frequency: 1176.45 MHz). The antenna 54A corresponds to an “antenna for satellite communications” to communicate with satellites.

The antenna 54A includes a circuit board 150, a dielectric body 151, and a radiation element 152.

The circuit board 150 is a dielectric plate material made of, for example, glass epoxy resin, and has a ground pattern (not illustrated) formed on its upper surface and a circuit pattern (not illustrated) formed on its lower surface. The circuit board 150 is secured, with a conductive screw, to seats 160 which are formed such that parts of the ground member 40A are bent. As a result, the ground pattern on the circuit board 150 and the ground member 40A are electrically connected to each other.

The circuit board 150 is connected to the connector 60A with a coaxial cable (not illustrated). Alternatively, the circuit board 150 is connected to the substrate 41A with a coaxial cable or the like (not illustrated), to thereby transmit signals received by the antenna 54A to the connector 60A via a circuit pattern (not illustrated) formed on the substrate 41A.

The dielectric body 151 is made of a dielectric material such as ceramics. The radiation element 152 supports radio waves in the L1 band, the L2 band, and the L5 band. A configuration is not limited to this, and may be a stacked patch antenna, a patch antenna configured to resonate with radio waves in a plurality of frequency bands, a patch antenna formed of sheet metal without using a dielectric material, or a patch antenna combining these.

Further, it is also possible to apply it to an antenna for a satellite positioning system capable of receiving circularly polarized signals using various feed systems, such as double- or quadruple-feed system, to employ, for example, such an embodiment in which a parasitic element is provided above the radiation element 152 to thereby improve directivity.

### Configuration of Antenna Device 30B

As illustrated in FIGS. 3 and 4B, the antenna device 30B is a complex antenna device accommodating a plurality of antennas, and includes a ground member 40B, a substrate 41B, antennas 50B to 53B, a connector 60B, and a cover 61B.

Blocks given the same reference numerals are the same between the antenna device 30A and the antenna device 30B. In other words, the ground member 40A, the substrate 41A, the antennas 50A to 53A, the connector 60A, and the cover 61A are the same as the ground member 40B, the substrate 41B, the antennas 50B to 53B, the connector 60B, and the cover 61B, respectively.

Further, an upright portion 100B and arm portions 110B, 111B of the antenna 50B are the same as the upright portion 100A and the arm portions 110A, 111A of the antenna 50A, respectively. Thus, a detailed description of each component of the antenna device 30B is omitted here.

Further, as with the end portion T3 of the substrate 41A, an end portion T4 of the substrate 41B also indicates a certain region including the end. FIG. 4B illustrates the rear end portion T4 of the substrate 41B.

In an embodiment of the present disclosure, the rear corresponds to “another (or the other) direction,” and the substrate 41B corresponds to a “second substrate.” Further, the upright portion 100B corresponds to a “second upright portion,” the arm portion 110B corresponds to a “second arm portion,” and the antenna 50B corresponds to a “second antenna element.” Further, the antenna 52B corresponds to a “second antenna for vehicle communications.”

### Electrical Characteristics of Antenna Device 10

Next, a description is given of the electric characteristics of part of the antennas included in the antenna device 10 and isolation between the antennas.

### Parasitic Capacitance of Antenna 50A, 50B

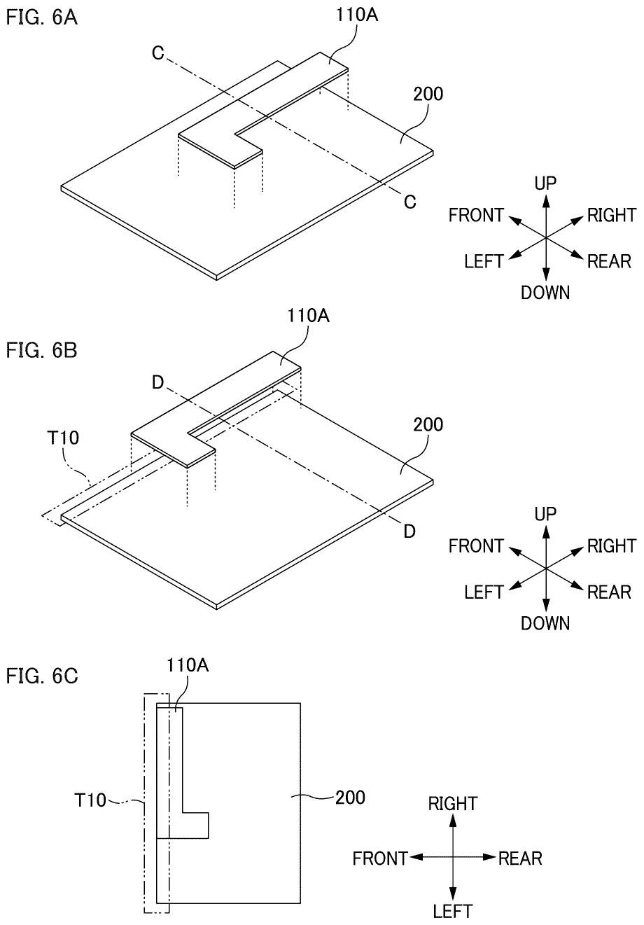

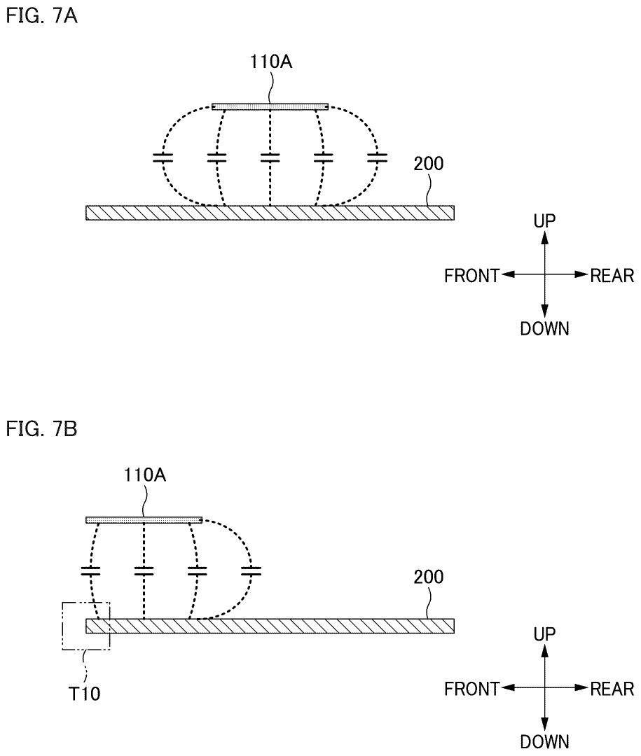

FIGS. 6A to 6C are each a schematic diagram illustrating the position of the arm portion 110A with respect to a ground member 200. FIGS. 7A and 7B are each a schematic diagram illustrating parasitic capacitance generated at the arm portion 110A. The ground member 200 is a substantially quadrilateral metal member used here, for convenience, to illustrate the parasitic capacitance generated at the arm portion 110A (described later).

When the arm portion 110A is disposed near the geometric center of the ground member 200 as illustrated in FIG. 6A, a relatively large parasitic capacitance is generated between the arm portion 110A and the ground member 200 as illustrated in FIG. 7A. FIG. 7A is a diagram illustrating the relationship between a parasitic capacitance and a cross-section taken along the line C-C of FIG. 6A.

Meanwhile, when the arm portion 110A is disposed at a front end portion T10 of the ground member 200 as illustrated in FIGS. 6B and 6C, the parasitic capacitance between the arm portion 110A and the ground member 200 decreases as illustrated in FIG. 7B. FIG. 7B is a diagram illustrating the relationship between a parasitic capacitance and a cross-section taken along the line D-D of FIG. 6B. Further, the arm portion 110A is disposed here such that the front edge of the ground member 200 is aligned with the front edge of the arm portion 110A extending in the left-right direction, in a plan view.

Accordingly, when the arm portion 110A is disposed at the end portion T10 of the ground member 200, the parasitic capacitance generated at the arm portion 110A can be reduced. As a result, it is possible to improve the characteristics of the arm portion 110A with respect to low-frequency-band radio waves (e.g., VSWR: Voltage Standing Wave Ratio).

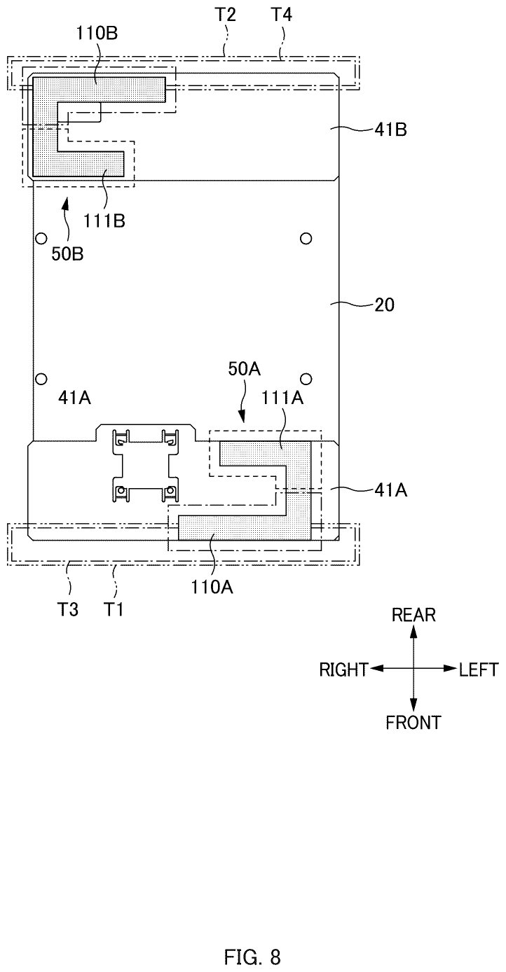

As described earlier, the “end portion T10 of the ground member 200” indicates a certain region including the end of the ground member 200 (see, for example, the dot-dot-dash line in FIG. 6B). Further, the “certain region” is, for example, a region in which effects on the parasitic capacitance can be reduced so that the antenna 50A including the arm portion 110A can obtain desired frequency-band characteristics. Although a description has been given using FIGS. 6A to 6C by way of example, the same applies to the “certain regions” of the end portions T1, T2 in the antenna device 10 illustrated in FIG. 8 as well.

FIG. 8 is a plan view illustrating the positions of the antennas 50A, 50B in the antenna device 10 of an embodiment of the present disclosure. In an embodiment of the present disclosure, the substrate 41A (antenna device 30A) is disposed at the ground member 20 such that the front edge of the substrate 41A is aligned with the front edge of the ground member 20 in a plan view. However, the substrate 41A (antenna device 30A) may be disposed such that the front end portion T3 of the substrate 41 overlaps with the front end portion T1 of the ground member 20, instead of the front edge of the substrate 41A being aligned with the front edge of the ground member 20.

Then, the arm portion 110A extends rightward, from the upright portion 100A, along the front edge of the substrate 41A, in other words, the front edge of the ground member 20. As a result, even in a case where the length of the arm portion 110A in the left-right direction is long, the parasitic capacitance of the arm portion 110A can be reduced.

Further, as with the substrate 41A, the substrate 41B (antenna device 30B) is disposed at the ground member 20 such that the rear edge of the substrate 41B is aligned with the rear edge of the ground member 20 in a plan view. As a result, because the arm portion 110B is disposed so as to overlap with the rearward end portion T2 of the ground member 20, the parasitic capacitance of the arm portion 110B can be reduced.

Accordingly, in an embodiment of the present disclosure, it is possible to improve the frequency characteristics (particularly, the characteristics with respect to radio waves in the low frequency band) while reducing the heights of the antennas 50A, 50B.

### Isolation between Antennas

In an embodiment of the present disclosure, the antenna device 30A including the antennas 50A to 54A and the antenna device 30B including the antennas 50B to 53B are disposed with the metallic reinforcement member R1 interposed therebetween.

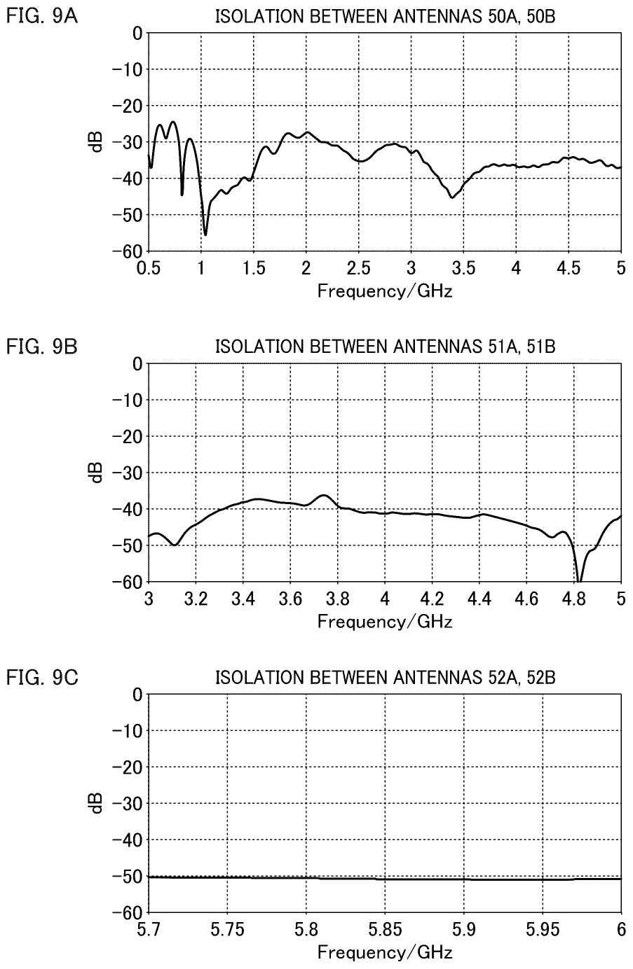

Accordingly, isolation between the antennas can be improved, as compared to a case where, for example, a plurality of antennas supporting the same communication standard are accommodated in a single antenna device. FIG. 9A illustrates isolation between the antennas 50A and 50B supporting Sub-6 radio waves in LTE or 4G, for example. In an embodiment of the present disclosure, isolation characteristics of substantially −30 dB or more can be obtained in the frequency band supported by the antennas 50A, 50B.

FIG. 9B illustrates isolation between the antennas 51A and 51B supporting Sub-6 radio waves in LTE or 5G, for example. In an embodiment of the present disclosure, isolation characteristics of substantially -40 dB or more can be obtained in the frequency band supported by the antennas 51A, 51B.

FIG. 9C illustrates isolation between the antennas 52A and 52B supporting V2X radio waves, for example. In an embodiment of the present disclosure, isolation characteristics of substantially −50 dB or more can be obtained in the frequency band supported by the antennas 52A, 52B.

As such, in an embodiment of the present disclosure, the antenna devices 30A, 30B each include a plurality of antennas that have favorable isolation characteristics while supporting the same communication standard (e.g., antennas 50A, 50B). Accordingly, communication quality can be improved even when Multiple-Input Multiple-Output (MIMO) communication is performed using a plurality of antennas supporting the same communication standard (e.g., antennas 50A, 50B).

### Directivity of antennas 52A, 52B for V2X

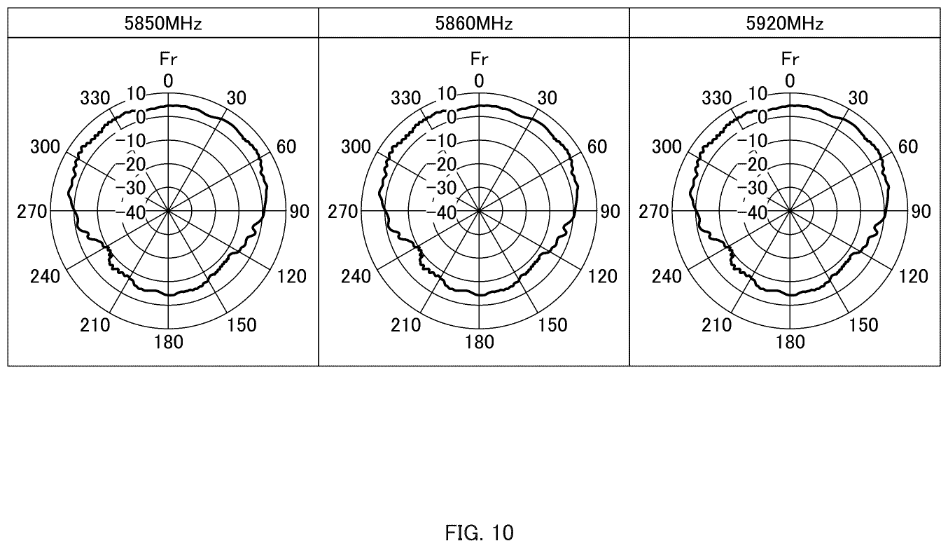

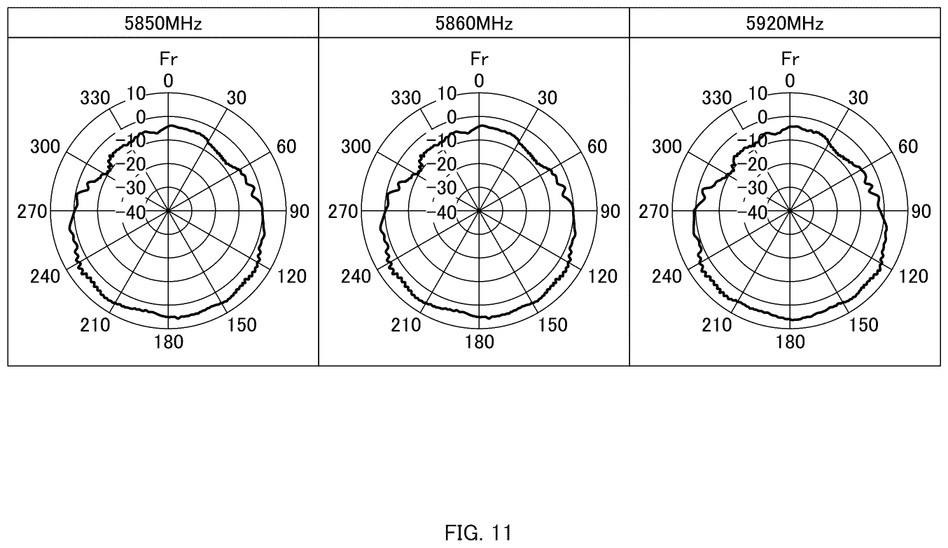

FIG. 10 is a diagram illustrating the horizontal directivity of the antenna 52A, and FIG. 11 is a diagram illustrating the horizontal directivity of the antenna 52B. In FIGS. 10 and 11, the azimuth angle of direction 0° corresponds to the front direction, and the azimuth angle of direction 90° corresponds to the right direction.

The antenna 52A at the front has higher gain at the front than at the rear as illustrated in FIG. 10, and the antenna 52B at the rear has higher gain at the rear than at the front as illustrated in FIG. 11. By installing such antennas 52A, 52B at the antenna devices 30A, 30B, respectively, for example, favorable vehicle-to-vehicle communication can be achieved.

Further, with the antenna device 30A and the antenna device 30B being disposed with the reinforcement member R1 interposed therebetween, it is possible to improve the isolation characteristics between the antennas 50A to 54A and the antennas 50B to 54B, and also with the antenna device itself being divided, for example, to have a configuration in which the antenna 52A disposed in front of the reinforcement member R1 is dedicated to improvement in the forward directivity and the antenna 53B disposed on the rear side relative to the reinforcement member R1 is dedicated to improvement in the rearward directivity, it is possible to achieve miniaturization while improving the performance thereof, thereby improving the degree of freedom of installation thereof at the vehicle.

### Antenna Device 300

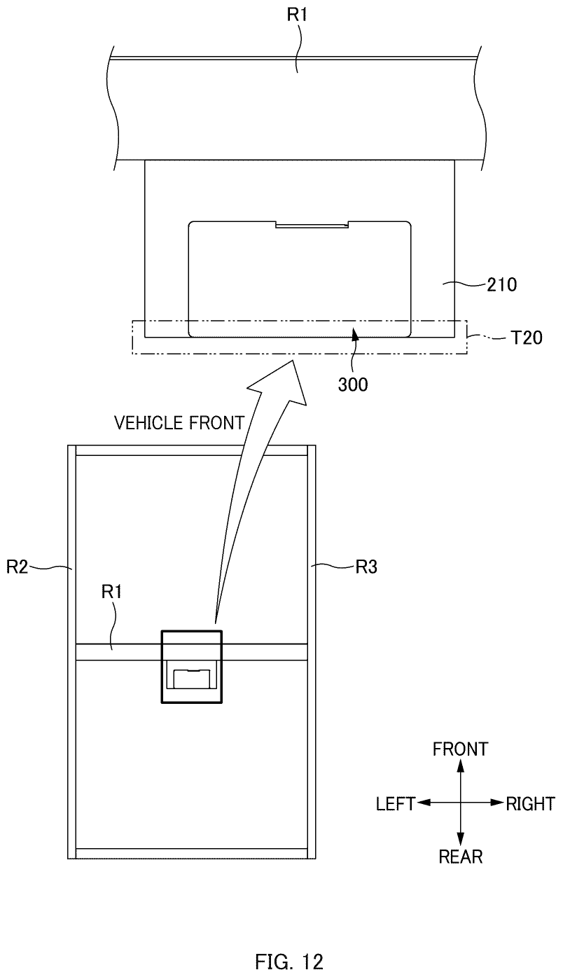

The antenna device 10 is attached to the reinforcement member R1 of the vehicle C via the ground member 20, however, an antenna device 300 may be attached via a ground member 210 as illustrated in FIG. 12, for example.

The ground member 210 is, as with the ground member 20, a substantially quadrilateral metallic plate-shaped member and is attached to a lower side of the reinforcement member R1 with a conductive screw (not illustrated).

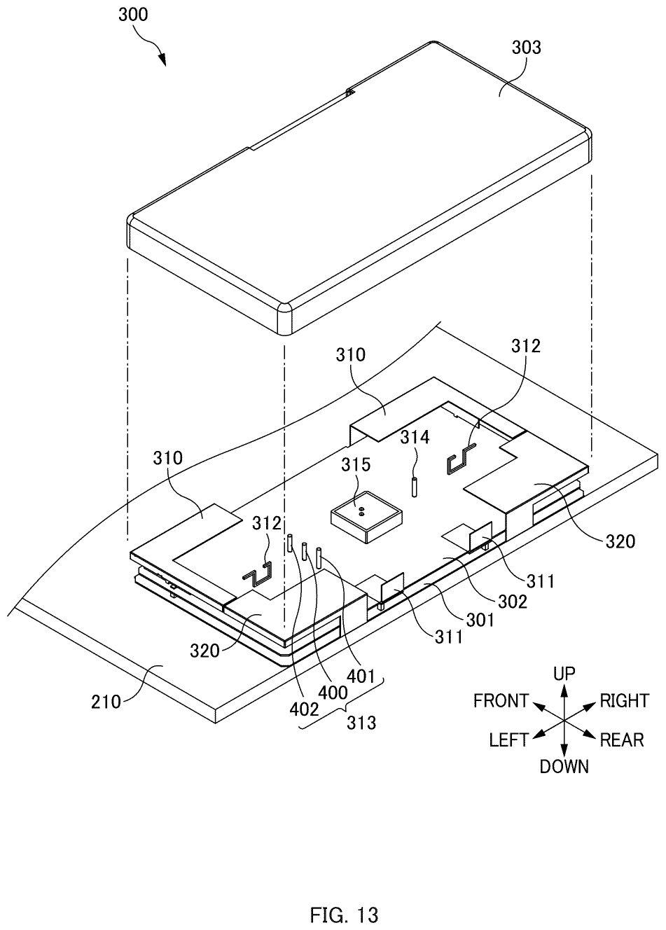

The antenna device 300 is, as illustrated in FIG. 13, a complex antenna device including a plurality of antennas and is placed at a rear end portion T20 of the ground member 210 (see FIG. 12). The antenna device 300 includes a ground member 301, a substrate 302, a cover 303, antennas 310 to 315, and a parasitic element 320.

The ground member 301 is a metallic member functioning as a ground for the antenna device 300, and is connected to the ground member 210 with a conductive screw (not illustrated).

The substrate 302 is a member at which the antennas 310 to 315 and the like are placed, and is provided at an upper side of the ground member 301. Although the antenna device 300 includes the ground member 301 in an embodiment of the present disclosure, the present disclosure is not limited to this, and the substrate 302 may be disposed directly at the ground member 210.

By covering the substrate 302 from above, the cover 303 forms, with the ground member 301, an accommodation space to accommodate the plurality of antennas.

The antenna 310 is, as with the antenna 50A, a telematics antenna supporting radio waves in the Sub-6 band for LTE and 4G, for example. The parasitic element 320 is disposed at the rear of the antenna 310. The parasitic element 320 is an element to adjust the impedance of the antenna 310 and improve the characteristics thereof particularly in the low frequency band.

The antenna 311 is, as with the antenna 51A, a telematics antenna supporting radio waves in the Sub-6 band for 5G, for example.

The antenna 312 is an antenna supporting radio waves in the frequency band used for Wi-Fi or Bluetooth, for example.

The antenna 313 is an antenna supporting radio waves in the frequency band used for V2X, for example. The antenna 313 is an antenna with higher gain at the front than at the rear, and includes elements 400 to 402.

The element 400 is a bar-shaped conductor that is used for V2X communications and operates as a monopole antenna for vertical polarization.

The element 401 is a parasitic element placed on the rear side relative to the element 400, and the element 402 is a parasitic element placed in front of the element 400. The element 401 is an antenna to operate as a so-called reflector, and the element 402 is an antenna to operate as a so-called wave director. Because these elements 401, 402 are provided, the gain of the antenna 313 is improved at the front of the vehicle C.

The antenna 314 is, as with the antenna 313 (element 400), an antenna supporting radio waves in the frequency band used for V2X, for example. The antenna 314 is an antenna with higher gain at the rear than at the front. As with the antenna 313, the antenna 314 may include a parasitic element.

An antenna 315 is a patch antenna for a satellite positioning system to receive circularly polarized signals using the double-feed system, for example.

The antenna device 300 is larger in size in the front-rear and left-right directions than the antenna device 10, for example. Thus, a larger number of antennas can be disposed in the antenna device 300 without impairing isolation between the antennas.

Further, the parasitic element 320 to adjust the impedance of the antenna 310 is disposed near the antenna 310. Thus, it is possible to improve the characteristics of the antenna 310 in the low frequency band.

### Summary

The antenna device 10 of an embodiment of the present disclosure has been described above. The antenna device 30A is attached to the ground member 20 extending frontward from the reinforcement member R1. The arm portion 110A of the antenna 50A included in the antenna device 30A is provided in such a manner as to overlap with a front end portion 1 of the ground member 20 in a plan view (see, for example, FIGS. 4A and 8). Accordingly, in an embodiment of the present disclosure, it is possible to reduce parasitic capacitance at the antenna 50A, thereby being able to improve the characteristics of the antenna 50A particularly in the low frequency band.

Further, the substrate 41A of the antenna device 30A is disposed at the front end portion T1 of the ground member 20. As illustrated in, for example, FIG. 4A, the arm portion 110A extends rightward, from the upright portion 100A, along the front edge of the substrate 41A. Thus, it is possible to reduce parasitic capacitance, while the antenna 50A has a long distance from the feed point 125A to the right tip end of the arm portion 110A.

Further, the antenna device 30B of an embodiment of the present disclosure is disposed at the ground member 20 extending rearward from the reinforcement member R1. The arm portion 110B of the antenna 50B included in the antenna device 30B is provided in such a manner as to overlap with the rear end portion T2 of the ground member 20 (see, for example, FIGS. 4B and 8). Accordingly, in an embodiment of the present disclosure, it is possible to reduce parasitic capacitance at the antenna 50B, thereby being able to improve the characteristics of the antenna 50B particularly in the low frequency band.

Further, the antenna device 30B is disposed, at the ground member 20, on the side opposite to (on the rear side relative to) the antenna device 30A provided at the front, with the metallic reinforcement member R1 interposed therebetween. Accordingly, in an embodiment of the present disclosure, it is possible to improve isolation characteristics between the antennas included in the antenna devices 30A, 30B (e.g., between the antennas 50A and 50B).

Further, the substrate 41B of the antenna device 30B is disposed at the rear end portion T2 of the ground member 20. As illustrated in, for example, FIG. 4B, the arm portion 110B extends leftward, from the upright portion 100B, along the rear edge of the substrate 41B. Thus, it is possible to reduce parasitic capacitance, while the antenna 50B has a long distance from a feed point (not illustrated) to the left tip end of the arm portion 110B.

Further, the antenna devices 30A, 30B include the antennas 52A, 52B for V2X, respectively. The antennas 52A, 52B are provided, with the metallic reinforcement member R1 interposed therebetween. Accordingly, in an embodiment of the present disclosure, it is possible to improve the isolation characteristics between the antennas 52A and 52B (see, for example, FIG. 9C).

Further, the antenna device 30A includes the antenna 54A for satellite communications. Thus, the antenna device 10 results in a complex antenna device including various types of antennas.

Further, the antenna device 10 (antenna device 30A) is disposed at the ground member 20 configured to be attached to the reinforcement member R1. Although it is assumed here that the antenna device 30A includes the ground member 40A, the present disclosure is not limited to this. For example, in the antenna device 30A, the substrate 41A may be directly attached to the ground member 20, without the ground member 40A. Such a configuration also can achieve the same or similar effects as in an embodiment of the present disclosure.

### Other

An antenna device includes: a first substrate disposed at the ground member configured to be attached to a reinforcement member of a vehicle, the ground member extending, from the reinforcement member, in one direction of a front direction and a rear direction of the vehicle; a first antenna provided at the first substrate; a second substrate disposed at the ground member extending, from the reinforcement member, in the other direction, different from the one direction, of the front direction and the rear direction; and a second antenna provided at the second substrate.

In such a case, the antenna devices 30A, 30B are disposed, with the metallic reinforcement member R1 interposed therebetween. Accordingly, it is possible to improve isolation between antennas that are included in the antenna devices 30A, 30B, respectively, and that support the same frequency.

Embodiment(s) of the present disclosure described above is/are simply to facilitate understanding of the present disclosure and is/are not in any way to be construed as limiting the present disclosure. The present disclosure may variously be changed or altered without departing from its essential features and encompass equivalents thereof.

### REFERENCE SIGNS LIST

10, 30A, 30B, 300 antenna device
20, 40A, 40B, 200, 210, 301 ground member
41A, 41B, 302 substrate
50A to 54A, 50B to 53B, 310 to 315 antenna
60A, 60B connector
61A, 61B, 303 cover
100A, 100B upright portion
110A, 110B arm portion
120A, 120B short-circuit portion
125A feed point
130A, 130B, 131A, 131B, 400 to 402 element
320 parasitic element
C vehicle
F frame
P roof panel
R1 reinforcement member
R1, R3 roof siderail
S space
T1 to T4, T10, T20 end portion
U vehicle interior ceiling surface

1. An antenna device comprising:
a first substrate disposed at an end portion of a ground member in one direction of a front direction and a rear direction of a vehicle, the ground member being attached to a reinforcement member of the vehicle; and
a first antenna element provided at the first substrate, the first antenna element including
a first upright portion formed to extend upright relative to the first substrate, and
a first arm portion extending from the first upright portion, and overlapping with the end portion of the ground member in a plan view.

2. The antenna device according to claim 1, wherein
the first arm portion extends, from the first upright portion, along an edge of the first substrate, the edge extending in a width direction of the vehicle.

3. The antenna device according to claim 1, comprising:
a second substrate disposed at an end portion of the ground member in another direction of the front direction and the rear direction of the vehicle, the other direction being different from the one direction; and
a second antenna element provided at the second substrate, the second antenna element including
a second upright portion formed to extend upright relative to the second substrate, and
a second arm portion extending from the second upright portion, and overlapping with the end portion of the ground member in the other direction, in a plan view.

4. The antenna device according to claim 3, wherein
the second arm portion extends, from the second upright portion, along an edge of the second substrate, the edge extending in a width direction of the vehicle.

5. The antenna device according to claim 3, wherein
a first vehicle communication antenna to communicate with a vehicle different from the vehicle is provided at the first substrate, the first vehicle communication antenna having higher gain in the one direction than in the other direction, and
a second vehicle communication antenna to communicate with a vehicle different from the vehicle is provided at the second substrate, the second vehicle communication antenna having higher gain in the other direction than in the one direction.

6. The antenna device according to claim 1, further comprising:
a satellite communication antenna to communicate with a satellite is provided.

7. An antenna device comprising:
a ground member attached to a reinforcement member of a vehicle, the ground member extending, from the reinforcement member, in one direction of a front direction and a rear direction of the vehicle;
a first substrate disposed at an end portion of the ground member in the one direction; and
a first antenna element provided at the first substrate, the first antenna element including
a first upright portion formed to extend upright relative to the first substrate, and
a first arm portion extending from the first upright portion, and overlapping with the end portion of the first substrate in the first direction, in a plan view of the first substrate.
